(19) United States
(12) Patent Application Publication
(10) Pub. No.: US 2022/0240461 A1
(43) Pub. Date: Aug. 4, 2022

(54) METHOD FOR GROWING HERBS

(71) Applicant: Shenandoah Growers Inc., Rockingham, VA (US)

(72) Inventor: Ulf JÖNSSON, Waterloo (BE)

(73) Assignee: Shenandoah Growers Inc., Rockingham, VA (US)

(21) Appl. No.: 17/470,702

(22) Filed: Sep. 9, 2021

Related U.S. Application Data
(63) Continuation of application No. 15/912,169, filed on Mar. 5, 2018, now abandoned.
Application No. 15/912,169 is a continuation of application No. 14/314,909, filed on Jun. 25, 2014, now abandoned.

(30) Foreign Application Priority Data
Jun. 26, 2013 (EP) 13173826.2

(51) Int. Cl. A01G 22/15

(52) U.S. Cl. CPC A01G 22/15

(57) ABSTRACT

A method for growing herbs includes planting a herb and allowing the herb to germinate, becoming a herb seedling and either transplanting to or maintaining the herb seedling in a restrictive container, where the herb seedling is held for a predetermined period of time before transplanting the herb seedling to a second stage,where the seedling is held in order to grow and develop a larger root system. Maintaining the herb seedling in a restrictive container has the effect that the herb's root system will be prevented from growing, in comparison to an herb planted in a nursery. The herb will essentially stop growing while the root system is restricted. Meanwhile the herb will continue maturing, developing oils which are more elastic. Herbs with more elastic oils will be significantly more resistant to cold temperatures at a harvesting size, compared to herbs that have not been transplanted to restrictive containers.

### PRIORITY STATEMENT

The present application is a continuation of U.S. patent application Ser. No. 15/912,169, filed on Mar. 5, 2018, and titled “Method for Growing Herbs,” which is a continuation of U.S. patent application Ser. No. 14/314,909, filed on Jun. 25, 2014, and titled “Method for Growing Herbs,” which claims priority under 35 U.S.C. §119 to European Patent Application No. EP 13173826.2, filed Jun. 26, 2013, and titled “Method of Growing Herbs,” the entire contents of each is hereby incorporated herein by reference.

### TECHNICAL FIELD

At least one embodiment of the present invention generally relates to the cultivation of herbs. Furthermore, at least one embodiment of the present invention generally relates to improving quality and cold resistance of herbs.

### BACKGROUND

Herbs are used for culinary purposes, in manufacturing and food industries. The major commercial form of culinary herbs is the dried product, in part because herbs in this form are easy to transport, store and market. A fairly recent development in herb production is fresh herbs, which may be sold in pots or in a harvested bundle. The herbs will provide a small volume of fresh material to households while, when sold in a pot, being an attractive ornamental plant. While fresh herbs are considered more flavorful and superior in quality to dried herbs, widespread commercialization of fresh pot herbs has been restricted due to high perishability and a relatively short shelf life. There are several methods to increase shelf life, mainly comprising cold storage and/or cold transportation or alternatively by using chemical- or biological agents to improve the general resistance or quality of the herb. Cold storage and/or cold transportation is an efficient method with which to reduce the metabolic activity of a plant, as the rate of biochemical reactions such as respiration in plants is reduced. However, some herbs such as basil and watercress cannot withstand low temperatures as their leaves will darken, discolor, and eventually collapse. Additionally, the aromatic oils may be affected, having a negative impact on the flavor. For these reasons for example basil should not be chilled below 15-10° C., as is common with cold storage and/or cold transport of other fresh herbs. Consequently, there are also methods to more specifically address the cold resistance, for example using temperature protective hoods, chemical- or biological agents or by cold hardening the plants during production.

Industrial greenhouse production of herbs commonly comprises the steps of sowing and allowing the seed to germinate in a germination chamber for approximately one to seven days, until it has become a seedling. The duration depends on the herb in question. The seedling will then generally be transplanted and/or moved to a nursery, where the root system is allowed to develop under optimal conditions, including, for example, controlled irrigation from above the herbs. The herb seedling is cultivated in the nursery for 10-14 days, after which the herb is transplanted and/or moved to a gully system in a green house. In the gully system the herbs may take as much water and fertilizer as needed from below, where a nourishing mix of this is provided. The herbs may be moved relative each other in the gully system, so that herbs may grow without blocking or being blocked until they are ready for harvest, usually this takes approximately 20-40 days. The total production time is in average four to seven weeks until the fresh herb pot is ready to be shipped, however this varies depending on the type of herb, the season and ambient conditions. The preferred harvesting time is also based on studies of at what maturity stage the flavor of the herb is preferable, and even the aesthetic aspect of the size of the herb, wherein the preferences may vary with the intended market.

Fresh herbs usually have a shelf life of 6-7 days if delivered undamaged to the store. The short shelf life and the sensibility to cold temperatures imply that fresh herbs and in particular basil has a relatively high waste rate.

### SUMMARY

At least one embodiment of the invention is directed to improving the cold resistance of herbs produced for fresh herb purposes, in particular for basil. A method is defined in the accompanying claims.

At least one embodiment of the present invention is based on the insight that when the germinated seedling is held in a restrictive container before a second stage of growing the herb matures and develops oils which are more elastic, which contribute to an improved resistance to cold temperatures. Simultaneously the herb growth rate is significantly limited. The producer may therefore advantageously keep the herb at a preferred, and to the market more appealing size, despite being older and more mature.

According to one aspect of at least one embodiment of the invention a method is provided for growing herbs. The method comprises planting a herb, allowing the herb to germinate until the herb has sprouted, and becomes a herb seedling, performing one of transplanting to or maintaining the herb seedling in a restrictive container, where the herb seedling is held for a predetermined period of time before transplanting the herb seedling to a second stage, where the seedling is held in order to grow and develop a larger root system.

### BRIEF DESCRIPTION OF THE DRAWINGS

For exemplifying purposes, the invention will be described in closer detail in the following with reference to embodiments thereof illustrated in the attached drawings, wherein:

FIG. 1 shows a perspective view, partly in cross-section, of a basil seedling in a restrictive container.

FIG. 2 shows a flow chart of the method according to an embodiment of the invention.

### DETAILED DESCRIPTION

According to one aspect of at least one embodiment of the invention a method is provided for growing herbs. The method comprises planting a herb, allowing the herb to germinate until the herb has sprouted, and becomes a herb seedling, performing one of transplanting to or maintaining the herb seedling in a restrictive container, where the herb seedling is held for a predetermined period of time before transplanting the herb seedling to a second stage, where the seedling is held in order to grow and develop a larger root system.

Transplanting the herb seedling to a restrictive container or maintaining the herb seedling in a restrictive container has the effect that the herb's root system will be prevented from growing, in comparison to when it is planted in a nursery. Because of this the herb will essentially stop growing while the root system is restricted. Meanwhile the herb will continue maturing, developing oils which are more elastic. More mature herbs, with more elastic oils, will be significantly more resistant to cold temperatures at a harvesting stage, compared to herbs that have not been transplanted to restrictive containers, and consequently have not reached a similar maturity degree when reaching the harvesting size.

In the context of at least one embodiment of the invention the term planting a herb is to be understood as meaning planting a herb seed, planting a prepared herb seedling already germinated from a herb seed, planting a herb cutling which is a sprout cut from an older plant, or planting an offshoot from another plant.

Furthermore in the context of at least one embodiment of the invention the herb may initially be planted in any container suitable for planting herbs and further on transplanted to a restrictive container according to the method, advantageously the herb may also be planted directly in the restrictive container, and in this case the herb would not be transplanted to a restrictive container but maintained in the restrictive container it was planted in. This may have the benefit of decreasing the number of manual work steps and it may also decrease the risk of damage to the herb.

Transplanting to or maintaining the herb seedling in restrictive containers provides the additional advantage that the output of a production facility may be increased by up to 25% as an effect of the smaller sized restrictive containers as compared to a nursery, which means that the herb seedlings may consequently be placed in closer proximity to one another for a larger part of the herb's life cycle.

According to at least one exemplary embodiment of the present invention the method for growing herbs for fresh herb purposes is advantageously applied to production of one of the herbs: basil, coriander, or dill.

The effect of improved cold resistance is particularly noticed on the herb basil. Furthermore, the method provides the added effect of improved flavor in herbs such as coriander and dill.

According to one exemplary embodiment of the invention the herb seedling is held in the restrictive container for a period in the range of 14-25 days, advantageously in the range of 18-25 days, and more preferably in the range of 21-23 days.

The period the herb seedling is held in the restrictive container may vary depending on the type of herb and also on the ambient conditions during growing. However, as mentioned above, the important factor is that the herb seedling is held in the restrictive container long enough to develop sufficiently elastic oils for improved cold resistance and/or improved flavor.

Furthermore, according to one exemplary embodiment the second stage lasts for a period of 13-30 days, preferably in the range of 13-28 days and more preferably in the range of 13-22 days.

According to yet one exemplary embodiment of the invention the method further comprises a third stage wherein the herb seedling is provided progressively increased free surrounding space to grow until harvesting size is reached.

In the context of at least one embodiment of the invention the second stage may be a nursery and the third stage may be cultivation in a gully system. It is however also conceivable that the herb seedling is held in only one consecutive step after it has been moved from the restricting container and until it has reached harvest size.

According to one exemplary embodiment of the present invention, wherein when the method comprises a third stage, the second stage, during which the seedling is cultivated for growing and developing a root system, lasts for a period of 3-15 days, preferably in the range of 5-12 days and more preferably in the range of 8-10 days.

Furthermore, according to one exemplary embodiment of the invention the third stage for cultivation until harvesting size is reached, lasts for a period of 10-19 days, advantageously in the range of 10-17 days and more advantageously in the range of 13-16 days.

In one example embodiment of the present invention the total time of production from sowing to harvesting is in the range of 36-50 days, advantageously in the range of 40-50 days and more advantageously in the range of 42-47 days.

According to at least one exemplary embodiment of the method according to the invention the herbs are transplanted into restrictive containers in close proximity, wherein every 70-120 restrictive containers occupy an area of 0.15-0.20 m2.

According to at least one exemplary embodiment the herbs are transplanted to the second stage of the method, wherein every 8-60 containers occupy an area of 0.2-0.3 m2.

In one exemplary embodiment of the invention the herb is held at a temperature in the range of 1-20 degrees Celsius during production, preferably in the range of 1-13 degrees Celsius.

According to one exemplary embodiment of the invention the restrictive container is a plug pot or a plug comprised on a plug tray.

According to at least one exemplary embodiment of the invention the plug or plug pot has a smaller opening diameter than 60 mm and a smaller height than 80 mm, and preferably a smaller opening diameter than 25 mm and a smaller height than 35 mm.

In the context of at least one embodiment of the invention the opening refers to the opening of the plug, wherein the herb is planted or transplanted. Additionally, the opening diameter may be interpreted as the diameter of a circle essentially sharing a plane spanned by the opening of the plug, wherein all edges of the opening are within the circle. Furthermore, the height should be understood as the distance from the opening of the plug to the other end, along the plug's central axis.

According to at least one exemplary embodiment, the plug has a rectangular cross-section, wherein each side is smaller than 60 mm and preferably smaller than 25 mm, and wherein the plug has a smaller height than 80 mm and preferably a smaller height than 30 mm.

Those skilled in the art will realize that different features of the present invention may be combined to create embodiments other than those described in the following.

In the following detailed description, preferred embodiments of the present invention will be described. However, it is to be understood that features of the different embodiments are exchangeable between the embodiments and may be combined in different ways, unless anything else is specifically indicated. Even though in the following description, numerous specific details are set forth to provide a more thorough understanding of the present invention, it will be apparent to one skilled in the art that the present invention may be practiced without these specific details. In other instances, well known constructions or functions are not described in detail, so as not to obscure the present invention.

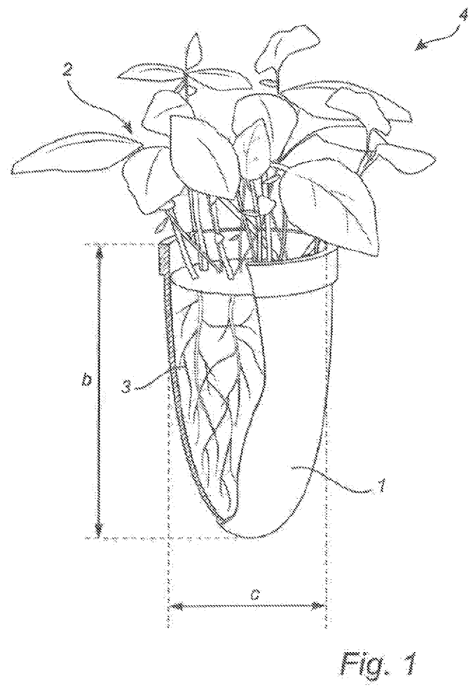

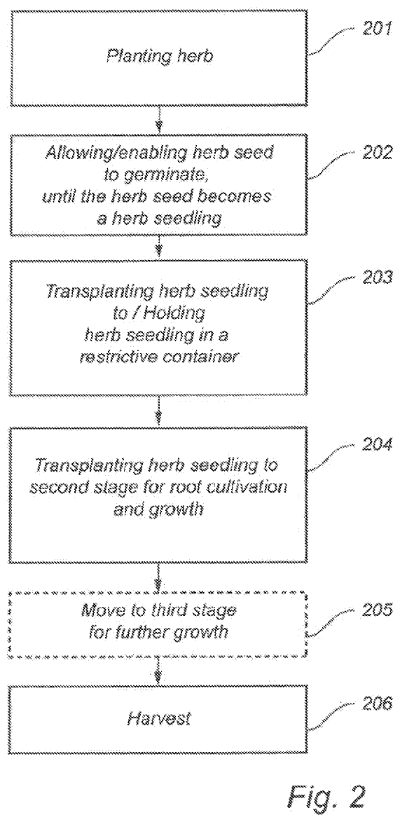

With reference to FIG. 1 and FIG. 2, one example embodiment of the method applied to the production of fresh basil will be described, starting with the step 201, wherein the basil seeds are sown. In the context of the invention it may be advantageous to sow directly into a restrictive container as this will save the effort of transplanting to the restrictive container after germination. During germination 202 the herbs are kept in a high humidity environment to trigger the seeds to start growing, becoming basil seedlings in this example embodiment.

After germination 202, which for basil takes approximately three days, the seedling 2 is maintained in a stage 203 where the container 1 will relatively soon be restrictive to the growth of the basil's root system 3. The restrictive container 1 used in stage 203, applied to the production of basil, is adapted to have a diameter c which is 25 mm or less and a height b that is 35 mm or less. Depending on environmental conditions the basil's root system 3 will typically outgrow the container within approximately five days, at which time the growth rate of the seedling 2 is essentially halted. The method according to the invention dictates that the herb is maintained in this restrictive container stage 203 for an extended period of time to at least partly achieve the objectives. In the example embodiment applied to basil the extended period last for an additional 17 days on average over the seasons, totaling 22 days on average for this stage 203. However, while maintained in this stage the basil is developing and becoming more mature. Since the restrictive container is relatively small and as the herbs will not grow so large at this stage there is room for approximately 25% more herb seedlings, for a larger part of the production cycle as compared to common growing of herbs.

The herb seedling 4 is thereafter transplanted to a second stage 204 after being held in the restrictive container. This stage may sometimes be referred to as the nursery, where the herb seedlings are cultivated in larger pots to develop the root system and grow. At this stage the herbs may for example be irrigated and fertilized from above. In the example embodiment of the invention the basil is held in the second stage for approximately 5 days. This duration is an approximate average over the seasons.

The basil may be transplanted or moved to a third stage 205. At this stage the herbs take their water from below the containers, and the containers may advantageously be placed in gully systems where the herbs may be moved as they grow, so that they do not block each other. In this example embodiment, applied to basil, this stage 205 takes approximately 15 days until the the basil is ready for harvest 206. Again, this duration is an approximate average over the seasons. From sowing to harvesting, the method according to the invention takes approximately 45 days on average over the year.

A person skilled in the arts will realize that there are possible variations to each stage of the method and to the material used, for example the duration may vary slightly depending on the herb in question.

Sowing of seeds may vary a lot depending on the herb, as some seeds are advantageously sown on top of the soil while other herbs are preferably sown in crevasses before being covered by a layer of soil. As there are extensive records of preferable sowing methods for the different herbs and as this is not within the specific scope of the invention this text will not go into further detail on sowing, such as the varying aspects of for example selecting and preparing the seed, the soil mix, the number of seeds in each container, etc.

For example, while as previously described there may be advantages to sowing in the restrictive container 1, a person skilled in the arts will realize that it is possible to implement the method according to the present invention by sowing in containers only used for stage 201 or only for stages 201 and 202. Furthermore, it should be noted that procuring prepared containers with sown seeds and/or germinated seedlings and thereby omitting to perform stage 201 and/or stage 202, may also be possible within the scope of the invention. Similarly, a person skilled in the art will also realize that it may be possible to use cutlings from older herbs as an alternative substitute to the germinated seedlings.

There are several environmental parameters that may be changed at each stage to optimize or improve for example growth rate or development of the herb's essential oils. Unless specifically addressed, these parameters, such as humidity, temperature, light wavelength, emitted lighting effect, etc. may be changed as needed within the inventive concept to adapt to for example the herb, season or ambient conditions. It should be noted that in some production facilities there are separate chambers for each of the stages of the method, wherein the herb is moved between each stage. Each chamber may be controlled to provide environmental parameters that are suitable for its intended stage.

Alternatively, it may be possible to use one chamber for all stages of the method, or any number of chambers for the separate stages, wherein the environmental parameters may be controlled to be suitable for the current stage. Any alternative, with either one or more chambers is possible within the scope of the present invention.

The restrictive container may for production purposes be either one of a series of single containers that may be interconnected or comprised on a tray of restrictive containers such as plug trays. There is currently a variety of plug trays of various material, shape and size available on the market.

In one example embodiment of the invention, wherein the herb cultivated for fresh purposes is basil, the restrictive container is preferably a plug tray where each plug pot is smaller than 25 mm over the diameter and has a height/depth smaller than 35 mm. The plug may be essentially conical in shape, wherein the larger base is on top where the seed is sown, so that the seedling's root system grows in an essentially spiraling direction towards the bottom. However, it should be clear to the person skilled in the arts that the size and shape may vary slightly without adversely affecting the method.

The advantage of improved cold resistance to fresh pot basil will increase shelf life to more than the normal 6-7 days, and thereby providing a significant potential for decreasing the waste rate. Furthermore, there are additional advantages to using the same method on other herbs, for example coriander and dill will have improved flavor as the plants are more mature at harvest.

Such and other obvious modifications must be considered to be within the scope of the present invention, as it is defined by the appended claims. It should be noted that the above-mentioned embodiments illustrate rather than limit the invention, and that those skilled in the art will be able to perform many alternative embodiments of the method without departing from the scope of the appended claims.

I claim:

1. A method for growing herbs, comprising:
initiating the method by planting an herb seed, an herb cutling, or an off shoot;
after the germination of the herb seed, the herb cutling, or the offshoot into an herb seedling, initiating a first growth stage by transplanting the herb seedling into a first container that includes a first end with a first diameter, a second end with a second diameter, and a height from the first end to the second end;
determining a first period of time that is required for the herb seedling to grow until the dimensions of the first container significantly slow or stop the growth of a root system of the herb seedling;
maintaining the herb seedling in the first container for a second period of time that is longer in duration than the first period of time;
after the second period of time, initiate a second growth stage by transplanting the herb seedling into a second container with dimensions that allow the root system of the herb seedling to grow;
maintaining the herb seedling in the second container for a third period of time;
after the third period of time, initiate a third growth stage by transplanting the herb seedling into a growing environment that does not restrict the growth of the herb seedling or the root system of the herb seedling; and
maintain the herb seedling in the growing environment for a fourth period of time.

2. The method of claim 1 wherein the second period of time is 14 days to 25 days.

3. The method of claim 2 wherein the second period of time is 18 days to 25 days.

4. The method of claim 2 wherein the second period of time is 21 days to 23 days.

5. The method of claim 1, wherein the third period of time is 3 days to 30 days.

6. The method of claim 5, wherein the third period of time is 3 to 15 days.

7. The method of claim 5, wherein the third period of time is 13 to 30 days.

8. The method of claim 1, wherein the fourth period of time is 10 days to 19 days.

9. The method of claim 8, wherein the fourth period of time is 10 days to 17 days.

10. The method of claim 8, wherein the fourth period of time is 13 days to 16 days.

11. The method of claim 1, where the first end of the first container is an opening with the first diameter equal to or less than 60 millimeters, the second end of the first container is a base with the second diameter less than the first diameter, and the height of the container is equal to or less than 80 millimeters.

12. The method of claim 1, where the first end of the first container is an opening with the first diameter equal to or less than 25 millimeters, the second end of the first container is a base with the second diameter less than the first diameter, and the height of the container is equal to or less than 35 millimeters.

13. The method of claim 1, wherein the herb seed, the herb cutling, or the offshoot is one of basil, coriander, or dill.

14. The method of claim 1, wherein the herb seedling is one of a plurality of herb seedlings, wherein during the first growth stage each of the plurality of herb seedlings is in one of a plurality of first containers, wherein the plurality of first containers are positioned in close proximity to one another such that 70 to 120 first containers occupy an area of 0.15 to 0.20 square meters.

15. The method of claim 1, wherein during the first growth stage, the herb seedling develops elastic oils.

16. The method of claim 15, wherein the elastic oils increase a resistance to cold of the herb seedling.

17. The method of claim 15, wherein the elastic oils enhance a flavor of the herb seedling.
